(19) United States
(12) Patent Application Publication
(10) Pub. No.: US 2003/0052291 A1
(43) Pub. Date: Mar. 20, 2003

(54) Electromagnetic valve for controlling an injection valve of an internal combustion engine

(76) Inventor: Wilfried Roth, Litzendorf (DE)

Correspondence Address: KENYON & KENYON, ONE BROADWAY, NEW YORK, NY, 10004, US

(21) Appl. No.: 10/204,759

(22) PCT Filed: Dec. 13, 2001
(86) PCT No.: PCT/DE01/04696

(30) Foreign Application Priority Data
Dec. 23, 2000 (DE) 10065015.5

(51) Int. Cl. F16K 31/02

(52) U.S. Cl. 251/129.15

(57) ABSTRACT

A solenoid valve for controlling an injection valve of an internal combustion engine has an electromagnet (29), a displaceable armature having an armature plate (28) and an armature pin (27), as well as a control valve element (25) which is displaced with the armature and which cooperates with a valve seat (24) for opening and closing a fuel discharge channel (17) of a control pressure chamber (14) of the fuel injector (1). The armature plate (28) is mounted on the armature pin (27) so as to be slidingly displaceable against the tensioning force of a restoring spring (35) acting on the armature plate (28) under the influence of the inert mass of the armature plate in the closing direction of the control valve element (25), and is pressed by the restoring spring (35) in its rest state against a stop element (26) attached to the armature pin (27). The stop element (26) engages in a recess (60) on the end face (47) of the armature plate (28) facing the electromagnet (29). The stop element (26) has a conical outer wall (51) on which a complementary conical inner wall section (61) of the recess (60) in the armature plate (18) comes to rest.

### BACKGROUND INFORMATION

The present invention relates to a solenoid valve for controlling an injection valve of an internal combustion engine according to the preamble of claim 1.

Such a solenoid valve, known for example from German Patent Application 196 50 865 A1, is used for controlling the fuel pressure in the control pressure chamber of an injection valve, such as the injector of a common rail injection system. The fuel pressure in the control pressure chamber controls the movement of a valve piston using which an injection orifice in the fuel injector is opened or closed. The known solenoid valve has an electromagnet situated in a housing part, a displaceable armature, and a control valve element, acted upon by a closing spring in the closing direction and moved together with the armature, which cooperates with a valve seat of the solenoid valve and thereby controls the fuel discharge from the control pressure chamber. A known disadvantage of this solenoid valve is the armature bounce. When the magnet is switched off, the armature together with the control valve element of the closing spring of the solenoid valve is accelerated toward the valve seat in order to close a fuel discharge channel from the control pressure chamber. The impact of the control valve element on the valve seat can result in disadvantageous vibration and/or bouncing of the control valve element on the valve seat, thus impairing the control of the injection process. For this reason, in the solenoid valve known from German Patent Application 196 50 865 A1 the armature is designed in two parts, having an armature pin and an armature plate slidably mounted on the armature pin, so that when the control valve element impacts the valve seat, the armature plate is further displaced against the elastic force of a restoring spring. The restoring spring then brings the armature plate back to its starting position on a stop element on the armature pin. The two-part design of the armature reduces the effective decelerated mass and thus the kinetic energy of the armature striking the valve seat which creates the bouncing. The stop element for the armature plate is designed in the shape of an open annular disk having a U-shaped recess which is situated in an annular groove in the armature pin. On its end face which is directed toward the electromagnet, the armature plate has a recess having a rectangular cross section which concentrically surrounds the armature pin, the outer wall of the annular disk being separated by a portion of the circumferential inner wall of the recess so that the annular disk is secured to the armature pin with a small amount of play, yet is protected from slippage from the armature pin as a result of the recess. The restoring spring presses the armature plate in its rest position, together with the base of the recess, against the stop element.

### ADVANTAGES OF THE INVENTION

The solenoid valve according to the present invention having the characterizing features of claim 1 differs from the related art by the fact that the stop element has on at least a portion of its periphery a conical outer wall on which a complementary conical inner wall section of the recess in the armature plate comes to rest. As a result of this measure, when the armature plate strikes, the transmitted forces act not only axially on the stop element, but are also absorbed radially with respect to the direction of movement of the armature plate via the outer wall which is inclined by the cone angle. Bouncing of the armature plate from the stop element and rebound of the armature plate is thereby advantageously reduced. In addition, as a result of this measure, when the electromagnet is energized, the armature plate comes to rest on the stop element without lateral play, and tilting moments acting on the armature plate are reduced. The armature plate is guided by the engagement of the conical stop element in the complementary recess. It is thus possible to shorten the guide sleeve which slides on the armature pin and to reduce the mass of the armature plate, which in turn has a positive effect on the rebound characteristics of the armature plate. Brief rebound times for the armature plate are desirable, since an actuation of the solenoid valve results in a defined injection quantity only when the armature plate no longer rebounds. Furthermore, as a result of the conical design of the recess, an interfering ridge in the recess may be easily avoided during the manufacturing process.

Refinements and advantageous exemplary embodiments of the present invention are made possible by the features characterized in the subclaims.

Thus, it is particularly advantageous if the conical inner wall section of the recess in the armature plate comes to rest with a friction fit on the conical outer wall of the stop element. On account of the enlarged support surface of the armature plate on the stop element compared to the related art, the long-term stability of the solenoid valve is improved.

The conical inner wall section and the conical outer wall of the stop element may advantageously form a hydraulic damping device which makes it possible to damp rebounding of the armature plate on the armature pin.

The stop element may be mounted in an annular groove in the armature pin in order to secure the stop element to the armature pin. It is particularly advantageous if the stop element has a multi-part, in particular a two-part, design having a first part and at least one additional part, the parts being concentrically situated around the armature pin in a plane perpendicular to the direction of movement of the armature pin and in each case coming to rest on an inner wall section on the annular groove. Using these measures, the stop element may be easily secured to the armature pin without play. The support surface of the stop element on the armature pin is enlarged in comparison to the known solenoid valves, resulting in increased stability. An impact of the armature plate, acted on by the restoring spring, on the stop element causes a radial force to be applied to the first part and the at least one additional part of the stop element as a result of the lateral surface of the stop element which is inclined by the cone angle. Lateral play between the armature plate and the armature pin is thus advantageously avoided.

It is also advantageous for a first side of the stop element facing the electromagnet to have a shoulder on its outer edge. A fuel discharge channel may advantageously be formed by the shoulder and a through opening provided in the armature plate which connects the armature space in the solenoid valve to a through opening which is formed in the electromagnet and which is connected to a low-pressure fuel connection of the solenoid valve.

### DRAWINGS

Exemplary embodiments of the present invention are illustrated in the drawing and are explained in the description below.

FIG. 1 shows a cross section through the upper portion of an injection valve having a solenoid valve, which is known from the related art;

FIG. 2a shows a top view of an embodiment of the stop element of a solenoid valve according to the present invention;

FIG. 2b shows a cross section through FIG. 2a;

FIG. 3 shows the armature plate of a solenoid valve according to the present invention; and

FIG. 3 shows the armature plate, armature pin, stop element, and slide piece of a second embodiment of the solenoid valve according to the present invention in the assembled state without the restoring spring.

### DESCRIPTION OF THE EXEMPLARY EMBODIMENTS

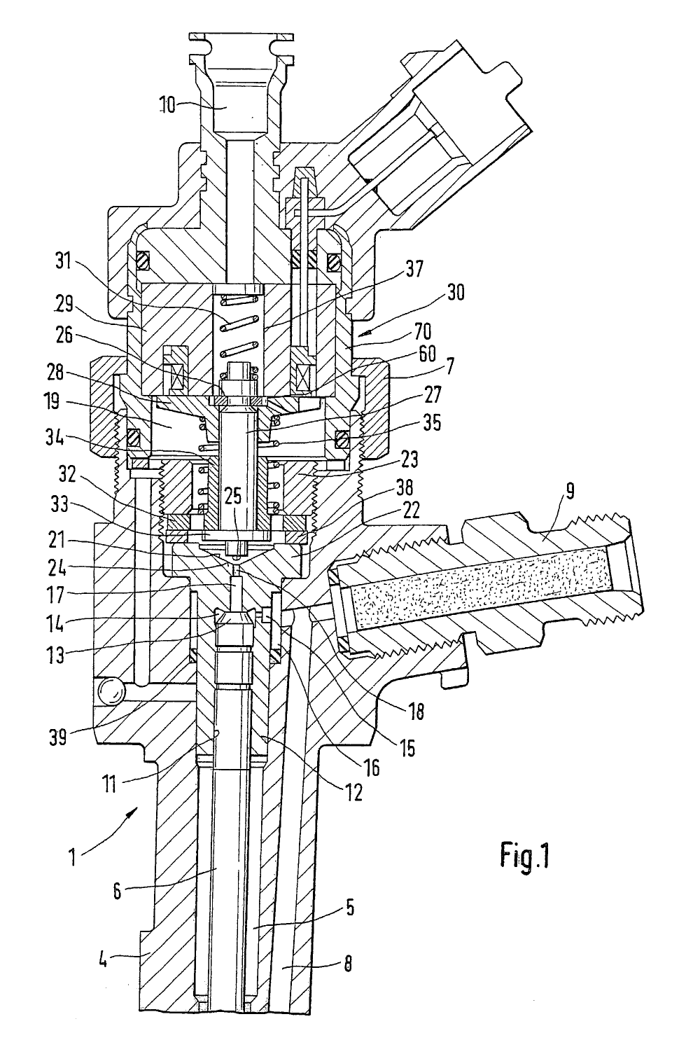

FIG. 1 shows the upper portion of an injection valve 1 known from the related art which is intended for use in a fuel injection system equipped with a high-pressure fuel accumulator which is continuously supplied with high-pressure fuel via a high-pressure feed pump. The illustrated fuel injector 1 has a valve housing 4 which contains a longitudinal borehole 5 in which a valve piston 6 is situated whose one end acts on a valve needle mounted in a nozzle body (not shown). The valve needle is situated in a pressure chamber which is supplied with high-pressure fuel via a pressure borehole 8. During an opening stroke displacement of valve piston 6, the valve needle is lifted against the closing force of a spring by the high fuel pressure in the pressure chamber which constantly acts on a pressure shoulder of the valve needle. The fuel is injected through an injection orifice, which is then connected to the pressure chamber, into the combustion chamber of the internal combustion engine. Lowering of valve piston 6 causes the valve needle to be pressed into the valve seat of the fuel injector in the closing direction, and the injection process is terminated.

As can be seen in FIG. 1, valve piston 6 is guided, at its end facing away from the valve needle, in a cylinder borehole 11 which is introduced in a valve piece 12 inserted into valve housing 4. In cylinder borehole 11, front face 13 of valve piston 6 encloses a control pressure chamber 14 which is connected to the high-pressure fuel connection via a supply channel. The supply channel is essentially designed in three parts. A borehole leading radially through the wall of valve piece 12, with the inner walls of the borehole forming an inlet throttle 15 along a portion of their length, is permanently joined to an annular space 16 which peripherally encloses the valve piece, the annular space in turn being permanently joined, via a fuel filter inserted into the supply channel, to the high-pressure fuel connection of a connecting piece 9 which is screwable into valve housing 4. Annular space 16 is sealed with respect to longitudinal borehole 5 by gasket 39. Control pressure chamber 14 is subjected to the high fuel pressure prevailing in the high-pressure fuel accumulator via inlet throttle 15. A borehole running in valve piece 12 coaxially to valve piston 6 branches off from control pressure chamber 14 and forms a fuel discharge channel 17 provided with an outlet throttle 18 which opens into a pressure relief chamber 19 connected to a low-pressure fuel connection 10, which in turn is connected to a fuel return of fuel injector 1 in a manner which is not further illustrated. The outlet of fuel discharge channel 17 from valve piece 12 is situated in the region of a conically countersunk portion 21 of the external front face of valve piece 12. Valve piece 12 is firmly braced against valve housing 4 in a flange region 22 via a screw element 23.

A valve seat 24 is formed in conical part 21 and cooperates with a control valve element 25 of a solenoid valve 30 which controls the fuel injector. Control valve element 25 is coupled to a two-part armature in the form of an armature pin 27 and an armature plate 28, the armature cooperating with an electromagnet 29 in solenoid valve 30. Solenoid valve 30 includes a housing part 60 which encloses an electromagnet, the housing part being firmly connected to valve housing 4 via screwable connection means 7. In the known solenoid valve, armature plate 28 is mounted on armature pin 27 so as to be dynamically displaceable against the pretensioning force of a restoring spring 35 under the influence of the inert mass of the armature plate, and in the rest state is pressed by this restoring spring against a stop element 26 attached to the armature pin. With its other end, restoring spring 35 is supported against the housing by a flange 32 of a slide piece 34 which guides armature pin 27, the slide piece being firmly clamped to this flange in the valve housing between a spacing disk 38 placed on valve piece 12 and screw element 23. Armature pin 27, together with armature disk 28 and control valve element 25 coupled to the armature pin, are continuously acted upon in the closing direction by a closing spring 31 supported against the housing, so that control valve element 25 normally rests on valve seat 24 in the closed position. When the electromagnet is energized, armature plate 28 as well as armature pin 27, via stop element 26, are moved toward the electromagnet, thereby opening discharge channel 17 toward pressure relief chamber 19. An annular shoulder 33 is situated on armature pin 27 between control valve element 25 and armature plate 28 and strikes flange 32 when the electromagnet is energized, thereby limiting the opening stroke of control valve element 25. Spacing disk 38, situated between flange 32 and valve piece 12, is used to adjust the opening stroke.

The opening and closing of the fuel injector is controlled by solenoid valve 30 as described below. Armature pin 27 is constantly acted upon in the closing direction by closing spring 31, so that when the electromagnet is not energized, control valve element 25 rests on valve seat 24 in the closed position and control pressure chamber 14 is closed toward pressure relief side 19, with the result that high pressure which is also present in the high-pressure fuel accumulator builds up very rapidly via the supply channel. The pressure in control pressure chamber 14 generates, via the surface of front face 13, a closing force on valve piston 6 and the valve needle connected to it which is greater than the forces acting in the opening direction as a result of the high pressure present. When control pressure chamber 14 is opened toward pressure relief side 19 by the opening of the solenoid valve, the pressure diminishes very rapidly in the small volume of control pressure chamber 14 since the control pressure chamber is uncoupled from the high-pressure side via inlet throttle 15. As a result, the force from the high-pressure fuel at the valve needle which acts on the valve needle in the opening direction predominates, so that the valve needle moves upward, thereby opening the at least one injection orifice for injection. However, when solenoid valve 30 closes fuel discharge channel 17, the pressure in control pressure chamber 14 resulting from the fuel continuing to flow through supply channel 15 may build up again, so that the original closing force is present and the valve needle of the fuel injector closes.

When the solenoid valve closes, closing spring 31 abruptly presses armature pin 27 together with control valve element 25 against valve seat 24. A disadvantageous bounce or rebound of the control valve element arises due to the fact that the impact of the armature pin on the valve seat creates an elastic deformation of the valve seat which has the effect of an energy accumulator, a portion of the energy in turn being transmitted to the control valve element, which then together with the armature pin bounces from valve seat 24. The known solenoid valve shown in FIG. 1 therefore uses a two-part armature having an armature plate 28 which is uncoupled from armature pin 27. When control valve element 25 bounces on valve seat 24, armature plate 28 is further displaced against the elastic force of a restoring spring 35. Restoring spring 35 then brings armature plate 28 back to its starting, i.e., rest position on stop element 26 on the armature pin. It is thus possible to reduce the total mass striking the valve seat. However, armature plate 28 may disadvantageously rebound. In the known solenoid valve shown in FIG. 1, stop element 26 is designed as one part in the form of an annular disk having a U-shaped recess which is situated in an annular groove on armature pin 27. To this end, during the manufacture of the solenoid valve, armature plate 28 is moved downward against the tensioning force of restoring spring 35, and stop element 26 is pushed radially with respect to the axis of armature pin 27 onto the armature pin. When armature plate 28 springs back, stop element 26 penetrates into a recess 60 on the side of armature plate 28 facing electromagnet 29. The stop element is thereby protected from slippage from armature pin 27.

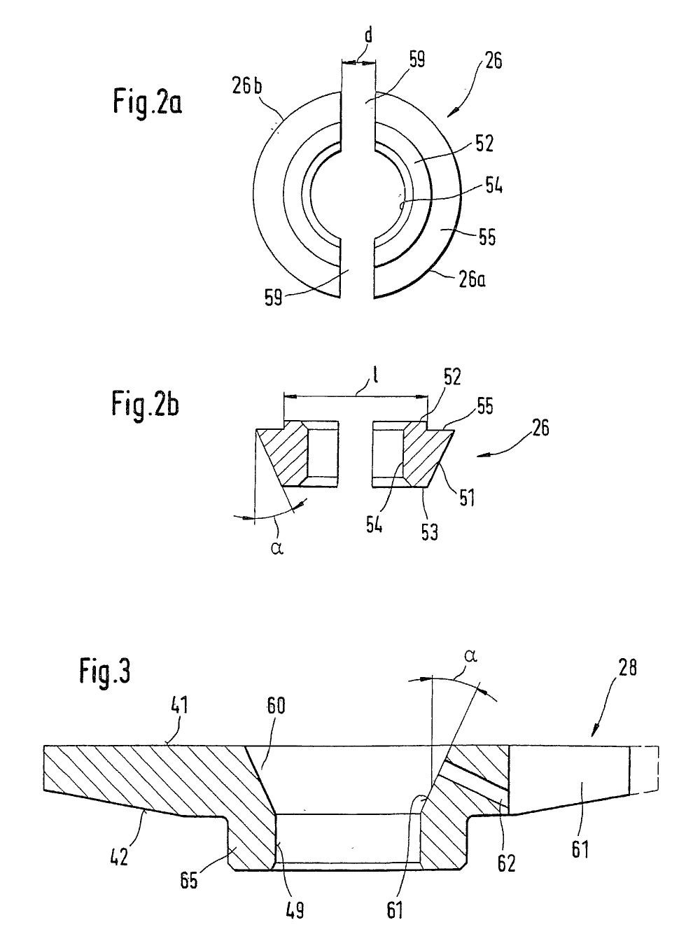

A first embodiment of stop element 26 of the solenoid valve according to the present invention is illustrated in FIGS. 2a and 2b. In the embodiment illustrated, stop element 26 is designed in two parts. However, the stop element may also have a three-part or multi-part design. It is also possible to design the stop element as one part having an annular cross section and to secure the stop element to the armature pin in a suitable manner. However, the design shown in FIGS. 2a and 2b, in which stop element 26 is composed of two parts, is particularly advantageous. Stop element 26 essentially has the shape of a truncated cone having a conical outer wall and an axial through opening, the truncated cone being divided into two sections 26a and 26b, which are C-shaped as seen from the top view, by a radial joint line 59 having a gap width d. Each section 26a, 26b has an upper side 52, a lower side 53, a conical partial outer wall 51, and a cylindrical inner wall section 54 for support on armature pin 27. In a preferred embodiment, cone angle α of the stop element is between 10° and 40°, in particular 25°. As seen in FIG. 2b, in the embodiment shown here upper side 52 of each of the two sections 26a, 26b has an annular shoulder 55 on the outer edge. In one position in which both sections 26a and 26b are situated on the armature pin, diametrical distance 1 between the two shoulder edges corresponds to the diameter of armature pin 27.

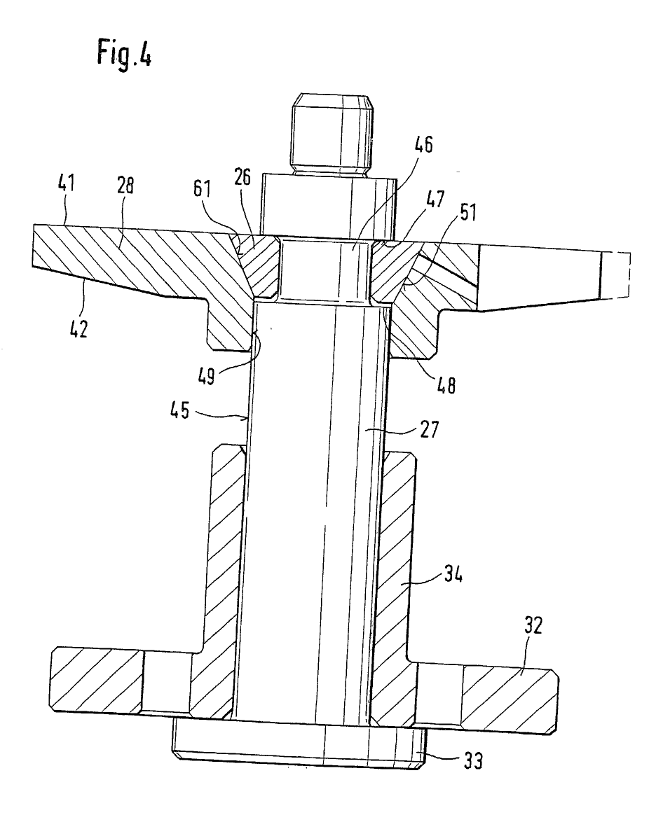

FIG. 3 shows associated armature plate 28 of the solenoid valve according to the present invention. Identical parts are denoted by the same reference numbers. Armature plate 28 has a front face 41, which in the installed state faces electromagnet 29, and a side 42, facing away from the electromagnet, from which a guide piece 65 projects, an axial through opening 49 passing through the guide piece for accommodating armature pin 27. Through opening 49 opens into a recess 60 on front face 41 of the armature plate, recess 60 having a conical inner wall 61 which is designed to be complementary with outer wall 51 of stop element 26 and which therefore has the same cone angle α. Recess 60 and opening 49 form a funnel-shaped geometry. A segment of armature plate 28 has an indentation 61. The inner edge of indentation 61 is connected to recess 60 via a borehole 62. Borehole 62 opens into conical outer wall 61.

FIG. 4 shows in the assembled state armature pin 27 together with armature plate 28 and stop element 26, and a slide piece 34 which guides armature pin 27. Restoring spring 35 is not shown. In contrast to FIG. 2a and FIG. 2b, shoulder 55 is not shown in the embodiment illustrated in FIG. 4. Instead of the parts shown in FIG. 1, the arrangement illustrated in FIG. 4 may be installed in the solenoid valve. During installation of the arrangement shown in FIG. 4, armature plate 28 is first pushed down against the tensioning force of restoring spring 35 (not shown). Both C-shaped parts 26a and 26b may then be pushed into an annular groove 46 in the armature pin. The distance of side walls 47 and 48 from annular groove 46 is slightly greater than the thickness of the two parts 26a and 26b, so that these parts may be easily pushed in. When armature plate 28 springs back, parts 26a and 26b penetrate into recess 60 of the armature plate until conical outer wall sections 51 come to rest with a friction fit on conical inner wall section 61 of recess 60. Outer wall sections 51 which are inclined by the cone angle cause force to be radially applied by restoring spring 35 on both parts 26a and 26b, thereby clamping armature pin 27 in the region of annular groove 46 between parts 26a and 26b which act as clamping jaws.

The impact of the armature plate on stop element 26 also causes both parts 26a and 26b to come to rest on upper side wall 47 of annular groove 46. In addition, it is advantageous for a hydraulic damping space to be formed when armature plate 28 approaches stop element 26 between conical inner wall 61 and conical outer wall 51. The fuel displaced from the decreasing gap between stop element 26 and recess 60 exerts a restoring force on armature plate 28 which counteracts restoring spring 35, so that the impact of the armature plate on the stop element is damped.

Annular shoulder 55 on upper side 52 of stop element 26 facing the electromagnet is not shown in FIG. 4. However, as can be seen in FIG. 2b in conjunction with FIG. 4, shoulder 55 together with borehole 62 which is provided in armature plate 28 may form a fuel discharge channel which connects pressure relief chamber 19 in the solenoid valve to low-pressure fuel connection 10 via opening 37 provided in electromagnet 29.

What is claimed is:

1. A solenoid valve for controlling an injection valve of an internal combustion engine, comprising an electromagnet (29), a movable armature having an armature plate (28) and an armature pin (27), and a control valve element (25) which moves with the armature and which cooperates with a valve seat (24) for opening and closing a fuel discharge channel (17) of a control pressure chamber (14) of the injection valve (1); the armature plate (28) being mounted on the armature pin (27) so as to be, under the influence of its inert mass, slidingly displaceable in the closing direction of the control valve element (25), against the tensioning force of a restoring spring (35) acting on the armature plate (28); and, in its nutral position, the armature plate being pressed by the restoring spring (35) against a stop element (26) situated on the armature pin (27); the stop element (26) engaging with a recess (60) on the end face (47) of the armature plate (28) facing the electromagnet (29); wherein the stop element (26) has, on at least a portion of its periphery, a conical outer wall (51) on which a complementary, conical inner wall section (61) of the recess (60) in the armature plate (18) comes to rest.

2. The solenoid valve as recited in claim 1, wherein the conical inner wall section (61) comes to rest on the conical outer wall (51) of the stop element (26), in a form-locked manner.

3. The solenoid valve as recited in claim 1 or 2, wherein the conical inner wall section (61) and the conical outer wall (51) of the stop element (26) form a hydraulic damping device, which allows rebounding of the armature plate (28) on the armature pin (27) to be damped.

4. The solenoid valve as recited in one of claims 1 through 3, wherein the stop element (26) is situated in an annular groove (46) of the armature pin (27).

5. The solenoid valve as recited in claim 4, wherein the stop element (26) has a multi-part, in particular a two-part, design having a first part (26a) and at least one additional part (26b), the parts (26a, 26b) being concentrically situated in the annular groove (46), around the armature pin (27), in a plane perpendicular to the direction of movement of the armature pin (27), and an inner wall section (54) of each part coming to rest on the annular groove (46).

6. The solenoid valve as recited in claim 5, wherein the armature plate (28) that is pressed against stop element (26) by restoring spring (35) causes a radial force to be applied to the first part (26a) and the at least one additional part (26b) of the stop element (26), thereby clamping the armature pin between the first part (26a) and the at least one additional part (26b).

7. The solenoid valve as recited in one of claims 1 through 6, wherein a first side (52) of the stop element (26) facing the electromagnet (29) has a shoulder (55) on its outer edge. (FIG. 2b)

8. The solenoid valve as recited in claim 7, wherein a fuel discharge channel is formed by the shoulder (55) and a through opening (62) provided in the armature plate (28), the fuel discharge channel connecting the armature space (19) of the solenoid valve (30) to a through opening (37), which is formed in the electromagnet (29) and is connected to a low-pressure fuel connection (10) of the solenoid valve.
